(19) United States
(12) Patent Application Publication
(10) Pub. No.: US 2007/0139694 A1
(43) Pub. Date: Jun. 21, 2007

(54) Document optimization selector

(75) Inventors: Jeffrey Kingsley, Macedon, NY (US); Elizabeth D. Wayman, Ontario, NY (US); Michael Branciforte, Rochester, NY (US); Michael R. Campanelli, Webster, NY (US)

Correspondence Address: Michael A. Schwartz, Esq.;Swidler Berlin LLP, Suite 300, 3000 K Street, N.W., Washington, DC, 20007, US

(73) Assignee: Xerox Corporation

(21) Appl. No.: 11/312,465

(22) Filed: Dec. 21, 2005

(51) Int. Cl. G06F 3/12; G06F 17/00

(52) U.S. Cl. 358/1.15; 715/526

(57) ABSTRACT

A method and apparatus include user interface and processing techniques that provide a solution for configuring an image processing path, and associated image processing module parameters, with minimal user input. The solution consists of two key components—a set of easily understood categories that describe the desired device output, and a system for mapping those categories to parameterized image processing paths. A method for processing a document comprises accepting a selection of a purpose for which a document is to be used, determining processing to be performed on the document based on the selection by loading rules controlling processing of the document based on the selection, wherein the rules comprises at least one script, scanning the document, determining a content of at least a portion of the document, applying the loaded rules to determine at least one technology to be used to process the document, and processing the document using the determined technology.

### TECHNICAL FIELD

The present technology relates to a user interface that may be used on a device known as a digital document system (DDS) that allows a user to control the image processing performed on a document by the device based on a purpose for which the document is intended to be used.

### BACKGROUND OF THE TECHNOLOGY

One common type of device is a digital document system (DDS) that includes a user interface, such as a scanner, fax machine, or multi-function device (MFD) including a scanner, fax, printer, etc. Such devices, for example, MFDs, are often being equipped with powerful image processing capabilities in order to support a wide variety of document processing requirements. As the number of features offered by the MFD increases, the number of controls for configuring the image processing typically increases, as does the complexity of the interaction between image processing controls. It is typically up to the user of the device to manipulate the device controls through some user interface (UI) to obtain the desired device output. A problem arises in that most users don't understand the image processing requirements for optimizing the output for their work. A need arises for a technique by which a user can control the image processing performed by a device in a way that is easy to understand and operate, yet which provides high-quality image processing output.

### SUMMARY OF THE TECHNOLOGY

The present technology includes user interface and processing techniques that provide a solution for configuring an image processing path, and associated image processing module parameters, with minimal user input. The solution consists of two key components: (1) a set of easily understood categories (or workflows) that describe the desired device output (or document processing), and (2) a system for mapping those categories to parameterized image processing paths.

A method for processing a document comprises accepting a selection of a purpose for which a document is to be used, determining processing to be performed on the document based on the selection by loading rules controlling processing of the document based on the selection, wherein the rules comprises at least one script, scanning the document, determining a content of at least a portion of the document, applying the loaded rules to determine at least one technology to be used to process the document, and processing the document using the determined technology.

The document may be processed by a device comprising at least one of a photocopier, a xerographic photocopier, a scanner, a printer, a xerographic printer, a fax machine, a xerographic fax machine, a multi-function device, or a xerographic multi-function device.

The method may further comprise accepting a selection of a fidelity of the document and wherein the document is processed according to the determined processing and the selected fidelity of the document. The method may further comprise displaying a representation of a knob or slider and accepting the selection of the fidelity of the document using the a representation of the knob or slider. The method may further comprise displaying a plurality of selectable choices, each representing a purpose for which the document is to be used. The may further comprise indicating a fidelity of the document associated with a selected choice of the plurality of selectable choices, upon selection of the selected choice. The script may comprise a plurality of commands specifying processing and parameters controlling levels of the processing.

### BRIEF DESCRIPTION OF THE DRAWINGS

Objects and advantages of the technology described in the present disclosure will be more clearly understood when considered in conjunction with the accompanying drawings, in which:

FIG. 1 is an exemplary diagram of a system to which the technology described in the present disclosure may be advantageously applied.

FIG. 2 illustrates an example of a user interface that provides document processing option selection.

FIG. 3 is an exemplary flow diagram of a process of document processing.

FIG. 4 is an exemplary block diagram of a document system in which the technology described in the present disclosure may be implemented.

### DETAILED DESCRIPTION

The present technology includes user interface and processing techniques that provide a solution for configuring an image processing path, and associated image processing module parameters, with minimal user input. The solution consists of two key components: (1) a set of easily understood categories (or workflows) that describe the desired device output (or document processing), and (2) a system for mapping those categories to parameterized image processing paths.

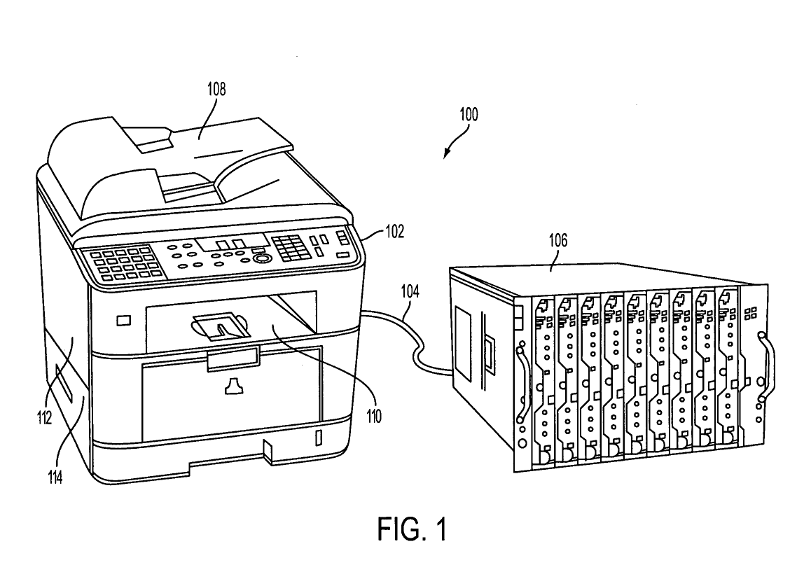

An example of a digital document system 100, to which the present technology may be advantageously applied, is shown in FIG. 1. In the example shown in FIG. 1 a multi-function device (MFD) 102 is communicatively connected by a network 104 to one or more servers 106. In this example, MFD 102 includes functions such as scanning, printing, faxing, and copying. These functions are provided by apparatus in MFD 102, such as a scanner 108, a printer 110, and a fax modem 112. These devices are typically all controlled by a processor 114, which manages the jobs being performed by each device. In addition, MFD 102 includes network connectivity via network 104 to one or more servers, such as server 106. Server 106 may provide functions such as storage of data from MFD 102, forwarding of data from MFD 102, etc. Server 106 may also provide more processing intensive functions such are optical character recognition (OCR), etc. It improves the user's workflow experience because the user gets feedback of remote job status at the user interface of the job originating (local) device.

It is to be noted that device 102, shown in FIG. 1, is merely an example of a system to which the present technology may be advantageously applied. The present technology is not limited to this system and in fact, contemplates application to and implementation in any type of system in which document processing may be performed. Additional non-limiting examples of systems to which the present technology may be applied include xerographic or other photocopiers, scanners, printers, fax machines, etc.

Typically, such document processing devices provide a UI that exposes controls and a variety of selectable options used to configure a particular job. Such options include:

designating the content of the original as photo and/or text;

color balance selections of normal, lively, cool, and warm;

contrast selection from dark to light;

color shift selection from pastel to vivid;

sharpness selection from soft to sharp;

background suppression;

selecting output or inprocessing resolution;

selecting between color, or black & white, or monochrome processing;

Selecting controls and options in the UI ultimately results in configuring the image processing path for the current job, and in some cases requires expert knowledge of the effects and workflow to produce optimum device output.

The present technology encapsulates expert knowledge in a process and makes available to the user a number of easy to understand options based on typical document processing applications. As a result, the user need only be knowledgeable about their application and need not be knowledgeable about the details of the document processing path. Rather, suitable document processing may be provided using as few as a single control.

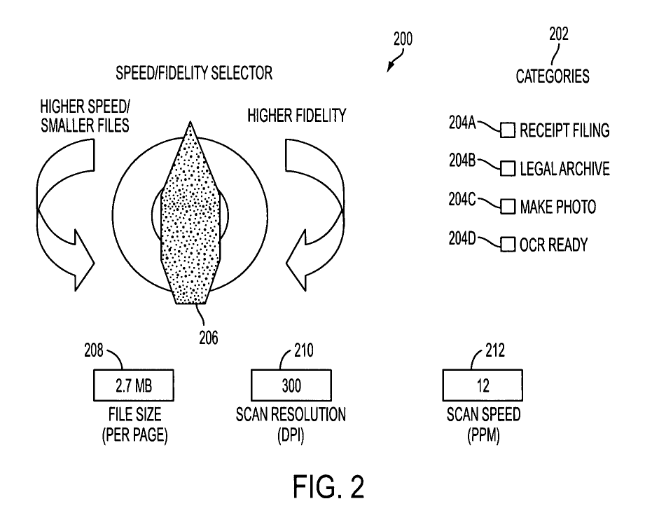

An example of a user interface 200 that provides document processing option selection is shown in FIG. 2. In the example, the user interface displays a number of category choices 202, such as choices 204A-D, from which novice users may select based on the purpose of the output document. For example, in FIG. 2, the user may choose from: OCR-ready 204D, Make photo 204C, Archive by legal standards 204B, and Receipt filing for reimbursement 204A. In addition, or alternatively, the option selection interface may be embodied as a dial, radio buttons, a paper form with checkboxes, or any other appropriate user interface. Optionally a Speed/Fidelity Selector 206 may be provided, which provides a symbolic representation illustrating a trade-off between scanning speed or file size of an input file and image fidelity, such as scanning resolution and the like. Speed/Fidelity Selector 206 allows the user to select the desired tradeoff between file size/scanning speed and image fidelity. In the example shown in FIG. 2, Speed/Fidelity Selector 206 is shown as a representation of a knob, which may be manipulated by a user by use of a mouse or other pointing device, by use of a touchscreen, or the like. However, other representations, such as a slider, and the like, may be used. User interface 200 could be a separate handheld device that communicates the selected use and fidelity to the scanning device. Likewise, user interface 200 could be represented on a sheet of paper having check boxes to indicate the selections made by the user. The sheet of paper would itself then be scanned before the document to be processed is scanned. The present technology is applicable to any and all forms of representation and/or input/display device.

The functions of category choices 202 and Speed/Fidelity Selector 206 may be independent, or they may be linked. For example, selection of each choice 204A-D may cause Speed/Fidelity Selector 206 to indicate a default or preferred Speed/Fidelity setting for the choice. The user may then proceed with that default or preferred setting, or the user may further modify the Speed/Fidelity setting for the choice, if desired. Optionally, additional information may be displayed based on the settings of Speed/Fidelity Selector 206 and category choices 202. For example, information such as file size (per page) 208 of the scanned document, the scan resolution (dots per inch) 210, and the scan speed (pages per minute) 212, may be displayed based on the settings of Speed/Fidelity Selector 206 and category choices 202.

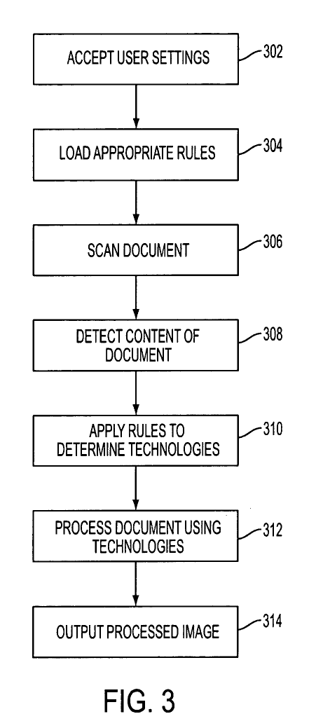

An exemplary flow diagram of a process of document processing 300 is shown in FIG. 3. The process begins with step 302, in which the document system accepts the user settings that have been selected. Typically, such user settings indicate a purpose for which the output document is to be used, and may also indicate a fidelity or quality desired for the document. In step 304, the appropriate rules to be used to process the document are loaded based upon the user settings that have been selected. These rules control the processing of the document including the scanning of the document, the application of document processing technologies to the document, and the output of the document. The nature of these rules may include not only the processing but final preparation of the document container for the user's application. For example, the document may be optimized for use in a networked environment by composing a PDF using the “linearized PDF” technique. Security of the document may also be included by use of encryption or document tracking technologies. In step 306, the document system scans the document to be processed based on the selected user settings. In step 308, the content of the scanned document is detected. For example, the document content may include photographs, text, graphics, or combinations of these. In step 310, the loaded rules and the detected content of the document are used to determine the appropriate document processing technologies to be used to process the document. In step 312, the determined document processing technologies are used to process the document. In step 314, the processed document is output.

It is to be noted that the processing performed using the present technology may be performed at the document system at which the user interface is present, or the processing performed using the present technology may be performed at some other device. Such a device, termed a remote device, may, for example, include one or more server systems that provide document processing. The present technology is applicable to implementation wholly on the document system, or partially on the document system and partially on one or more remote devices.

It is also to be noted that the rules that are used to process the document may have any format that provides appropriate control of the document processing. For example, the rules may comprise scripts that expressly set forth and control the processing performed. A script is a list of commands that can be executed without user interaction. Typically, a script may be considered to be a relatively simple form of programming language. However, programming languages of any level of simplicity or complexity may be used. Such scripts may include commands that specify processing and parameters that control levels of such processing. Such scripts may also include conditional statements that vary the processing based on particular conditions that do or do not occur. The present technology is not limited to script-based rules, but rather is applicable to any format of rules that provide appropriate control. For example, data tables including entries that control the processing performed and/or parameters that control the levels of processing performed may be used.

Typical technologies that may be utilized alone or in combination include color balance, contrast, color shift, sharpness, page positioning, compression, rotation, skew detection, etc. Each document processing category selection requires different technologies to produce optimum results. For example, scanning hard to read receipts on yellow paper would require grayscale scanning with adjusted histogram levels. Scanning high quality documents for legal archive is optimized by higher resolution but bi-level sampling. A set of rules is used to map from the user's choice to the combination of technologies to apply to the document. The user's document processing category selection combined with the user's fidelity selection is used to determine a set of technologies to be used. For example a low quality setting might be used to select a faster but lower quality scaling algorithm.

Some examples of rules include:

Receipt Filing:
Scan at mid-level resolution. If the speed/fidelity dial indicated higher fidelity, a higher scanning resolution would be used. A lower resolution would be used if the dial indicated smaller files.
Scan grayscale.
Adjust histogram levels to increase sharpness.
Increase contrast.
Remove background.

Legal Archive:
Scan at high resolution.
Detect areas of text or graphics and scan those areas binary and compress with lossless compression.
Detect areas of image and scan grayscale.
Compress with lossy compression. For a speed/fidelity dial setting of higher fidelity, the lossy compression parameters can be set to reduce loss.
Encode the device id into the resulting document for tracking purposes.

Make Photo:
A high resolution. If the speed/fidelity dial was set to higher speed, a lower resolution would be used.
Use AIE technology to balance color, contrast, etc.

For OCR Ready:
Use a mid-level resolution.
Scan binary.
Detect for skew and rotate through skew angle to align text to horizontal.
Remove background.
For a higher fidelity setting, a higher resolution would be used.

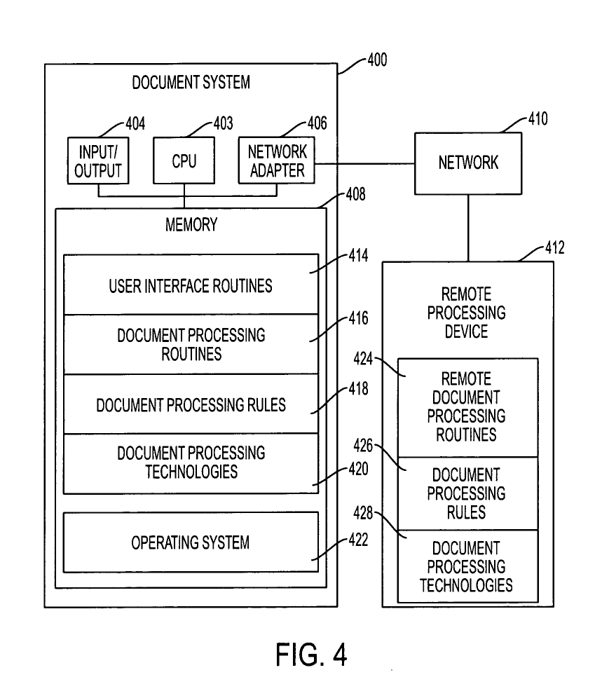

A block diagram of a document system 400, in which the technology described in the present disclosure may be implemented, is shown in FIG. 4. Document system 400 is typically a scanner, fax machine, printer, or multi-function device (MFD) including a scanner, fax, printer, etc. Included in document system 400 are controller 401 and other apparatus 402. Controller 401 is typically a microcomputer system, but may be a programmed general-purpose computer system, such as a personal computer, workstation, server system, and minicomputer or mainframe computer. Controller 401 includes processor (CPU) 402, input/output circuitry 404, network adapter 406, and memory 408. CPU 402 executes program instructions in order to carry out the functions of the present technology. Typically, CPU 402 is a microcontroller, microcomputer, or microprocessor, such as an INTEL PENTIUM® processor, but may also be a minicomputer or mainframe computer processor. Although in the example shown in FIG. 4, computer system 400 is a single processor computer system, the present technology contemplates implementation on a system or systems that provide multi-processor, multi-tasking, multi-process, multi-thread computing, distributed computing, and/or networked computing, as well as implementation on systems that provide only single processor, single thread computing. Likewise, the present technology also contemplates embodiments that utilize a distributed implementation, in which computer system 400 is implemented on a plurality of networked computer systems, which may be single-processor computer systems, multi-processor computer systems, or a mix thereof.

Input/output circuitry 404 provides the capability to input data to, or output data from, computer system 400. For example, input/output circuitry may include input devices, such as keyboards, mice, touchpads, trackballs, scanners, etc., output devices, such as video adapters, monitors, printers, etc., and input/output devices, such as, modems, etc. Network adapter 406 interfaces computer system 400 with network 410. Network 410 may be any standard local area network (LAN) or wide area network (WAN), such as Ethernet, Token Ring, the Internet, or a private or proprietary LAN/WAN. In this example, network 410 provides communicative connection with remote processing device 412.

Memory 408 stores program instructions that are executed by, and data that are used and processed by, CPU 402 to perform the functions of the present technology. Memory 408 may include electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an integrated drive electronics (IDE) interface, or a variation or enhancement thereof, such as enhanced IDE (EIDE) or ultra direct memory access (UDMA), or a small computer system interface (SCSI) based interface, or a variation or enhancement thereof, such as fast-SCSI, wide-SCSI, fast and wide-SCSI, etc, or a fiber channel-arbitrated loop (FC-AL) interface.

In this example, memory 408 includes user interface routines 414, document processing routines 416, document processing rules 418, document processing technologies 420, and operating system 422. User interface routines 414 perform processing that accepts input from a user of document system 400 and displays information to the user. For example, user interface routines 414 may implement a user interface such as that shown in FIG. 2, in which a number of category choices are displayed, from which novice users may select based on the purpose of the output document. Document processing routines 416 include software routines that implement the rules 418 that control the processing of the document including the scanning of the document, the application of document processing technologies 420 to the document, and the output of the document. Operating system 412 provides overall system functionality.

Remote device 412 includes remote document processing routines 416, document processing rules 426, and document processing technologies 428. Remote document processing routines 424 provide the capability to perform document processing using the present technology at remote devices in addition to, or instead of, performing such processing in document system 400. Remote document processing routines 424 include software routines that implement the rules 426 that control the processing of the document including the scanning of the document, the application of document processing technologies 428 to the document, and the output of the document.

Although specific embodiments of the present technology have been described, it will be understood by those of skill in the art that there are other embodiments that are equivalent to the described embodiments. Accordingly, it is to be understood that the technology is not to be limited by the specific illustrated embodiments, but only by the scope of the appended claims.

1. A method for processing a document comprising:
accepting a selection of a purpose for which a document is to be used;
determining processing to be performed on the document based on the selection; by loading rules controlling processing of the document based on the selection, wherein the rules comprises at least one script;
scanning the document;
determining a content of at least a portion of the document;
applying the loaded rules to determine at least one technology to be used to process the document; and
processing the document using the determined technology.

2. The method of claim 1, wherein the document is processed by a device comprising at least one of a photocopier, a xerographic photocopier, a scanner, a printer, a xerographic printer, a fax machine, a xerographic fax machine, a multi-function device, or a xerographic multi-function device.

3. The method of claim 1, further comprising accepting a selection of a fidelity of the document and wherein the document is processed according to the determined processing and the selected fidelity of the document.

4. The method of claim 3, further comprising displaying a representation of a knob or slider and accepting the selection of the fidelity of the document using the a representation of the knob or slider.

5. The method of claim 4, further comprising displaying a plurality of selectable choices, each representing a purpose for which the document is to be used.

6. The method of claim 5, further comprising indicating a fidelity of the document associated with a selected choice of the plurality of selectable choices, upon selection of the selected choice.

7. The method of claim 1, wherein the script comprises a plurality of commands specifying processing and parameters controlling levels of the processing.

8. Apparatus for processing a document comprising:
a processor operable to execute computer program instructions;
a memory operable to store computer program instructions executable by the processor; and
computer program instructions stored in the memory and executable to perform the steps of:
accepting a selection of a purpose for which a document is to be used;
determining processing to be performed on the document based on the selection; by loading rules controlling processing of the document based on the selection, wherein the rules comprises at least one script;
scanning the document;
determining a content of at least a portion of the document;
applying the loaded rules to determine at least one technology to be used to process the document; and
processing the document using the determined technology.

9. The apparatus of claim 8, wherein the document is processed by a device comprising at least one of a photocopier, a xerographic photocopier, a scanner, a printer, a xerographic printer, a fax machine, a xerographic fax machine, a multi-function device, or a xerographic multi-function device.

10. The apparatus of claim 8, further comprising accepting a selection of a fidelity of the document and wherein the document is processed according to the determined processing and the selected fidelity of the document.

11. The apparatus of claim 10, further comprising displaying a representation of a knob or slider and accepting the selection of the fidelity of the document using the a representation of the knob or slider.

12. The apparatus of claim 11, further comprising displaying a plurality of selectable choices, each selectable choice representing a purpose for which the document is to be used.

13. The apparatus of claim 12, further comprising indicating a fidelity of the document associated with a selected choice of the plurality of selectable choices, upon selection of the selected choice.

14. The apparatus of claim 8, wherein the script comprises a plurality of commands specifying processing and parameters controlling levels of the processing.

15. Apparatus for processing a document comprising:
means for accepting a selection of a purpose for which a document is to be used;
means for determining processing to be performed on the document based on the selection; by loading rules controlling processing of the document based on the selection, wherein the rules comprises at least one script;
means for scanning the document;
means for determining a content of at least a portion of the document;
means for applying the loaded rules to determine at least one technology to be used to process the document; and
means for processing the document using the determined technology.

16. The apparatus of claim 15, further comprising at least one of a photocopier, a xerographic photocopier, a scanner, a printer, a xerographic printer, a fax machine, a xerographic fax machine, a multi-function device, or a xerographic multi-function device.

17. The apparatus of claim 15, further comprising means for accepting a selection of a fidelity of the document and means for processing the document according to the determined processing and the selected fidelity of the document.

18. The apparatus of claim 17, further comprising means for displaying a representation of a knob or slider and means for accepting the selection of the fidelity of the document using the a representation of the knob or slider.

19. The apparatus of claim 18, further comprising means for displaying a plurality of selectable choices, each selectable choice representing a purpose for which the document is to be used.

20. The apparatus of claim 19, further comprising means for indicating a fidelity of the document associated with a selected choice of the plurality of selectable choices, upon selection of the selected choice.
